(19) United States
(12) Patent Application Publication
(10) Pub. No.: US 2013/0212534 A1
(43) Pub. Date: Aug. 15, 2013

(54) Expanding thumbnail with metadata overlay

(71) Applicants: Jerry Knight, San Francisco, CA (US); Ye-Jeong Kim, San Francisco, CA (US)

(72) Inventors: Jerry Knight, San Francisco, CA (US); Ye-Jeong Kim, San Francisco, CA (US)

(21) Appl. No.: 11/585,746

(22) Filed: Oct. 23, 2006

(51) Int. Cl. G06F 3/0481

(52) U.S. Cl. CPC G06F 3/04817
USPC 715/838

(57) ABSTRACT

Systems, methods, and computer program products for displaying graphical images are provided. In some implementations, a method is provided. The method includes displaying on a display device a collection of thumbnail images in a graphical user interface, each thumbnail image representing a distinct selectable object and receiving user inputs moving a cursor displayed on the display device. The method also includes determining whether the cursor is positioned within a region associated with a first one of the thumbnail images, and while the cursor is positioned within a region associated with the first one of the thumbnail images, displaying an enlarged version of the first one of the thumbnail images, the enlarged version including the image and an overlay over the image, the overlay displaying data associated with the object represented by the first one of the thumbnail images.

### BACKGROUND

This specification relates to displaying graphical images.

A user can interact with different applications through a user interface (e.g., a graphical user interface). The user interface of the application can allow a user to access objects stored locally, e.g., on the user's computer, or remotely, e.g., in some central repository. These objects (e.g., resources or other addressable objects including, for example, files and electronic documents) can be graphically represented in the user interface using images. For example, the objects can be represented as thumbnail images. The use of thumbnail images allows the user interface to present representations of multiple objects at the same time. Additionally, thumbnail images typically are reduced in size from the full version of the image, decreasing retrieval times for network based objects. While thumbnail images provide the user with a graphical representation of the underlying object, the small size of the thumbnail images limits the amount of information about each object that can be displayed.

### SUMMARY

Systems, methods, and computer program products for displaying graphical images are provided. In general, in one aspect, a method and a computer program product, respectively, are provided. The method and computer program product include displaying on a display device a collection of thumbnail images in a graphical user interface, each thumbnail image representing a distinct selectable object, receiving user inputs moving a cursor displayed on the display device, and determining whether the cursor is positioned within a region associated with a first one of the thumbnail images, and while the cursor is positioned within a region associated with the first one of the thumbnail images, displaying an enlarged version of the first one of the thumbnail images, the enlarged version including the image and an overlay over the image, the overlay displaying data associated with the object represented by the first one of the thumbnail images.

Implementations can include one or more of the following features. The region associated with the thumbnail image can be equal to the boundary of the thumbnail image. The overlay displaying additional data can further include a user interface element allowing access to the object represented by the thumbnail image. The overlay can be partially transparent. The data displayed in the overlay can be metadata associated with the object represented by the thumbnail image. The data displayed in the overlay can be based on the type of object represented by the thumbnail image. The method and computer program product can further include determining that the cursor is not positioned within the region associated with the first one of the thumbnail images and restoring the display on the display device to the previous collection of thumbnail images.

In general, in one aspect, a system is provided. The system includes a user interface device and one or more computers operable to interact with the user interface device and to display on a display device a collection of thumbnail images in a graphical user interface, each thumbnail image representing a distinct selectable object, receive user inputs moving a cursor displayed on the display device, and determine whether the cursor is positioned within a region associated with a first one of the thumbnail images, and while the cursor is positioned within a region associated with the first one of the thumbnail images, display an enlarged version of the first one of the thumbnail images, the enlarged version including the image and an overlay over the image, the overlay displaying data associated with the object represented by the first one of the thumbnail images.

Implementations of the system can include one or more of the following features. The one or more computers can include a server operable to interact with the user interface device through a data communication network, and the user interface device can be operable to interact with the server as a client. The user interface device can include a personal computer running a web browser or a mobile telephone running a wireless application protocol (WAP) browser. The one or more computers can include one personal computer, and the personal computer comprises the user interface device.

Particular embodiments of the subject matter described in this specification can be implemented to realize one or more of the following advantages. A user can controllably cause a system to display additional information about an object by moving a cursor over a thumbnail image representing the object. Enlarging the thumbnail by moving the cursor over the image allows the user to easily view additional information about the object

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example process for enlarging a thumbnail image including an overlay.

FIG. 2 illustrates an example user interface including a collection of thumbnail images.

FIG. 3 illustrates a portion of the example user interface of FIG. 2 following enlargement of a particular thumbnail image.

Like reference numbers and designations in the various drawings indicate like elements.

### DETAILED DESCRIPTION

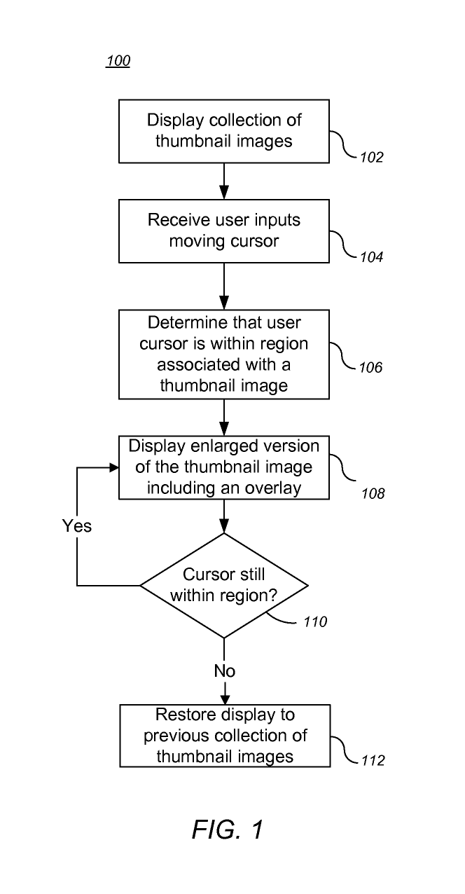

FIG. 1 illustrates an example process 100 for enlarging a thumbnail image including an overlay. For convenience, the process will be described with reference to an application program on a computer system that performs the process. The application displays a collection of thumbnail images (step 102). The thumbnail images are displayed on a display device in a window of a graphical user interface, for example, to represent distinct selectable objects.

In some implementations, the collection of thumbnail images provides access to the objects associated with the thumbnail images. For example, a user can select a particular thumbnail image (e.g., by clicking on the thumbnail image) in the collection of thumbnail images to access the object. The object accessed by the user can be, for example, a source image from which the thumbnail is derived, an application icon, a file, a destination location (e.g., a URL or a resource addressed by a URL), or another interface for accessing or inputting additional information.

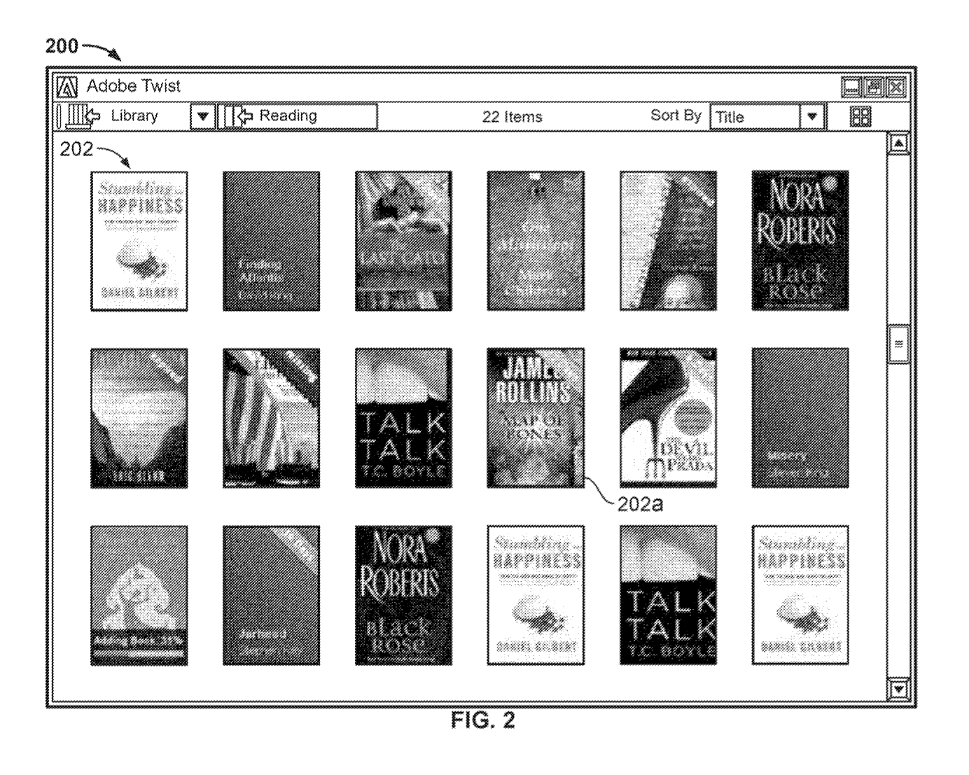

FIG. 2 illustrates an example user interface 200 including a collection of thumbnail images 202. The collection of thumbnail images 202 are presented in this example as an array of thumbnail images. The collection of thumbnail images 202 represents electronic books that may be available to the user. Each thumbnail image of the collection of thumbnail images 202 shows a book cover for a particular book, which is available to the user in an electronic version of the book. For example, thumbnail image 202a shows a book cover for the book “Map of Bones” by James Rollins. In some implementations, a user can select one or more of the displayed thumbnail images in the collection (e.g., by clicking on one or more particular thumbnail images using a cursor) in order to request some operation or service. Having selected a book, the user can be directed to an additional interface providing additional information for accessing the electronic book, including one or more of checking out the book, downloading the book, or purchasing the book.

As shown in FIG. 1, the application receives user inputs moving a cursor displayed on the display device (step 104). The window of the application within the graphical user interface generally has a focus (i.e., is selected as the active window) for cursor movements over the window to have effect. The application determines whether the cursor is positioned within a region associated with a thumbnail image (step 106). The cursor can be positioned within the region, for example, according to user movement of an input device (e.g., a mouse or trackball). As the user moves the cursor within the application interface, the position of the cursor can be tracked. Generally, the cursor position is determined by the operating system of the computer that the user is using and provided to applications running on that computer in the form of event data. For example, the user can move the cursor within the user interface to move over a particular thumbnail image (e.g., a roll-over of the thumbnail image with the cursor).

The region associated with the thumbnail image is generally defined by the boundary of the thumbnail image. In some implementations, the region associated with the thumbnail image can be larger or smaller than the area defined by the boundary of the thumbnail image.

In some implementations, the application displays an enlarged version of the thumbnail image using an animation sequence that smoothly enlarges the image. For example, when a user places the cursor over the thumbnail, the thumbnail can gradually enlarge to form the enlarged version of the thumbnail image. The enlarged version of the thumbnail image can provide greater detail than what is visible in the thumbnail image. Additionally, the user can select within the enlarged version of the thumbnail image (e.g., by clicking on the enlarged version of the thumbnail image) to access the object associated with the thumbnail image or request some other operation or service.

If the cursor is within the region associated with the thumbnail image, the application displays an enlarged version of the thumbnail image, the enlarged version including the image and an overlay (step 108). The overlay can include additional data associated with the object represented by the thumbnail image.

The overlay displayed with the enlarged thumbnail image can, for example, be partially transparent or opaque. The overlay can be within one or more borders of the enlarged version of the thumbnail image or can extend beyond the enlarged version of the thumbnail image. The overlay can cover the entire enlarged version of the thumbnail image. Alternatively, the overlay can cover some fraction of the enlarged version of the thumbnail image, for example, one-half or one-third of the enlarged version of the thumbnail image.

The additional data displayed in the overlay provides information associated with and relating to the object represented by the enlarged thumbnail image. For example, the additional data displayed can be metadata associated with the object and retrieved from a file (e.g., an XML file) associated with the thumbnail image. The additional data displayed can describe the object represented by the thumbnail image (e.g., the type and creator of the object). Alternatively, the additional data displayed can be access data associated with the object represented by the thumbnail image (e.g., when the object was last accessed or modified). The type of additional data displayed can be, for example, based on the type of object represented by the thumbnail image, or it can be defined by the user.

The overlay can also include a user interface element that a user can use to access the object represented by the thumbnail image. The user can make a selection within the overlay (e.g., a mouse click) in order to access the object. For example, the overlay can include a button to open the object represented by the enlarged thumbnail image. In another example, the overlay can include a pull-down menu which can provide additional data regarding the object, as well as one or more ways to interact with the object.

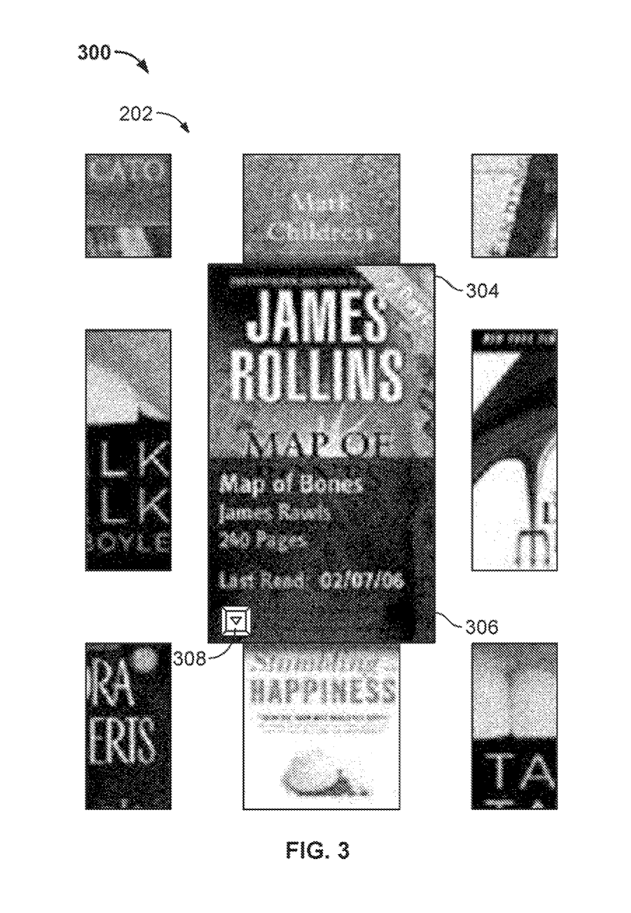

FIG. 3 illustrates a portion of the example user interface 200 of FIG. 2 following enlargement of a particular thumbnail image. The user interface 300 includes the collection of thumbnail images 202 shown in FIG. 2. However, the thumbnail image 202a of the collection of thumbnail images 202 has been replaced by an enlarged thumbnail image 304. The enlarged thumbnail image 304 is an expanded version of the book's cover shown in thumbnail image 202a. In some implementations, the expanded version has a greater resolution and more image data than the original thumbnail image 202a.

Additionally, the enlarged thumbnail image 304 includes an overlay 306 partially covering the enlarged thumbnail image 304. The overlay presents additional information about the electronic book represented by the enlarged thumbnail image 304. In particular, the overlay 306 includes metadata associated with the book shown in the enlarged thumbnail image 304. The metadata information presented in the overlay 306 includes the name of the book, its author, the number of pages, and when the book was last accessed. Additionally, the overlay 306 can include a tab 308 that allows the user to access a pull-down menu which provides additional options (e.g., deleting or opening the electronic book).

The application monitors whether or not the cursor remains in the region associated with the thumbnail image (step 110). If the cursor remains in the region, the application continues to display the enlarged thumbnail image with the overlay. However, when the application determines that the cursor is no longer positioned within the region associated with the thumbnail image, the application can restore the display to the previous collection of thumbnail images (step 112). For example, the enlarged version of the thumbnail image can be removed to display the original collection of thumbnail images again. In some implementations, the transition from the enlarged version to the normal version of the thumbnail image occurs with an animation that smoothly reduces the enlarged version of thumbnail image back to the original thumbnail image.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, which is generated to encode information for transmission to suitable receiver apparatus for execution by a computer. The computer-readable medium can be a machine-readable storage device, a machine-readable storage substrate, a memory device, a composition of matter affecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
displaying on a display device a collection of thumbnail images in a graphical user interface, each thumbnail image representing a distinct selectable product or service;
receiving user input moving a cursor displayed on the display device;
determining whether the cursor is positioned within a region associated with a first one of the thumbnail images, and while the cursor is positioned within the region, displaying an enlarged version of the first thumbnail image, the enlarged version having a boundary and including an overlay confined within the boundary of the enlarged version, the overlay at least partially covering the enlarged version and displaying (i) data associated with the product or service represented by the first thumbnail image and (ii) a pull-down menu for performing at least one action on the product or service represented by the first thumbnail image; and
removing the enlarged version responsive to when the cursor is no longer positioned in the region.

2. The method of claim 1, where the region associated with the thumbnail image is equal to the boundary of the thumbnail image.

3. The method of claim 1, where the overlay further includes a user interface element allowing access to the product or service represented by the thumbnail image.

4. The method of claim 1, where the overlay is partially transparent.

5. The method of claim 1, where the data displayed in the overlay is metadata associated with the product or service represented by the thumbnail image.

6. The method of claim 1, where the data displayed in the overlay is based on the type of product or service represented by the thumbnail image.

7. The method of claim 1, further comprising:
determining that the cursor is not positioned within the region associated with the first one of the thumbnail images; and
restoring the display on the display device to the previous collection of thumbnail images.

8. A computer program product, encoded on a tangible program carrier, operable to cause data processing apparatus to perform operations comprising:
displaying on a display device a collection of thumbnail images in a graphical user interface, each thumbnail image representing a distinct selectable product or service;
receiving user input moving a cursor displayed on the display device;
determining whether the cursor is positioned within a region associated with a first one of the thumbnail images, and while the cursor is positioned within the region, displaying an enlarged version of the first thumbnail image, the enlarged version having a boundary and including an overlay confined within the boundary of the enlarged version, the overlay at least partially covering the enlarged version and displaying (i) data associated with the product or service represented by the first thumbnail image and (ii) a pull-down menu for performing at least one action on the product or service represented by the first thumbnail image; and
removing the enlarged version responsive to when the cursor is no longer positioned in the region.

9. The computer program product of claim 8, where the region associated with the thumbnail image is equal to the boundary of the thumbnail image.

10. The computer program product of claim 8, where the overlay further includes a user interface element allowing access to the object product or service represented by the thumbnail image.

11. The computer program product of claim 8, where the overlay is partially transparent.

12. The computer program product of claim 8, where the data displayed in the overlay is metadata associated with the product or service represented by the thumbnail image.

13. The computer program product of claim 8, where the data displayed in the overlay is based on the type of product or service represented by the thumbnail image.

14. The computer program product of claim 8, further comprising:
determining that the cursor is not positioned within the region associated with the first one of the thumbnail images; and
restoring the display on the display device to the previous collection of thumbnail images.

15. A system comprising:
a user interface device; and
one or more computers operable to interact with the user interface device and to:
display on a display device a collection of thumbnail images in a graphical user interface, each thumbnail image representing a distinct selectable product or service;
receive user input moving a cursor displayed on the display device;
determine whether the cursor is positioned within a region associated with a first one of the thumbnail images, and while the cursor is positioned within the region, display an enlarged version of the first thumbnail image, the enlarged version having a boundary and including an overlay confined within the boundary of the enlarged version, the overlay at least partially covering the enlarged version and displaying data associated with the product or service represented by the first thumbnail image and (ii) a pull-down menu for performing at least one action on the product or service represented by the first thumbnail image; and
removing the enlarged version responsive to when the cursor is no longer positioned in the region.

16. The system of claim 15, wherein the one or more computers comprise a server operable to interact with the user interface device through a data communication network, and the user interface device is operable to interact with the server as a client.

17. The system of claim 16, wherein the user interface device comprises a personal computer running a web browser or a mobile telephone running a WAP browser.

18. The system of claim 15, wherein the one or more computers comprises one personal computer, and the personal computer comprises the user interface device.

19. The system of claim 15, where the region associated with the thumbnail image is equal to the boundary of the thumbnail image.

20. The system of claim 15, where the overlay further includes a user interface element allowing access to the product or service represented by the thumbnail image.

21. The system of claim 15, where the overlay is partially transparent.

22. The system of claim 15, where the data displayed in the overlay is metadata associated with the product or service represented by the thumbnail image.

23. The system of claim 15, where the data displayed in the overlay is based on the type of product or service represented by the thumbnail image.

24. The system of claim 15, where the one or more computers are further operable to:
determine that the cursor is not positioned within the region associated with the first one of the thumbnail images; and
restore the display on the display device to the previous collection of thumbnail images.
